(19) United States
(12) Patent Application Publication
(10) Pub. No.: US 2006/0222417 A1
(43) Pub. Date: Oct. 5, 2006

(54) Two-component developing device and image forming apparatus including the same

(75) Inventor: Tamotsu Shimizu, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co, Ltd., Suwon-si (KR)

(21) Appl. No.: 11/377,175

(22) Filed: Mar. 17, 2006

(30) Foreign Application Priority Data
Apr. 4, 2005 (KR) 2005-27944

(51) Int. Cl. G03G 15/09

(52) U.S. Cl. 399/276; 399/277

(57) ABSTRACT

A two-component developing device includes a photosensitive body, a hollow developing sleeve rotating oppositely to the photosensitive body and carrying a mixed developer of a carrier and a toner, and a magnet roller provided inside the developing sleeve and generating a predetermined magnetic field to form a developing zone between the photosensitive body and the developing sleeve, through which the toner is moved to the photosensitive body. The carrier has a magnetic force of 50 through 70 emu/g and a mean particle diameter of 20 through 40 μm; the mixed developer has a chargeability of 60 through 110%; and the diameter ratio of the developing sleeve (Dd) to the photosensitive body (Do) ranges between 0.73 and 1 (i.e., 0.73≦Dd/Do≦1). Thus, in the two-component developing device and image forming apparatus including the same, carrier adherence is prevented even through a carrier having a small diameter is used, thus improving resolution.

### CROSS-REFERENCE TO RELATED APPLICATION

This application claims the benefit of Korean Patent Application No. 2005-27944, filed on Apr. 4, 2005 in the Korean Intellectual Property Office, the disclosure of which is incorporated herein by reference.

### BACKGROUND OF THE INVENTION

1. Field of the Invention

An aspect of the present invention relates to a two-component developing device and an image forming apparatus including the same, and more particularly, to a two-component developing device capable of preventing carrier adherence and an image forming apparatus including the same.

2. Description of the Related Art

In general, an image forming apparatus includes a paper feeding device, a developing device, a fixing device, and a paper ejecting device. When the paper feeding device feeds a sheet of printing paper to the developing device, the developing device selectively applies a toner to the sheet of printing paper, thereby forming a predetermined image. Then, the fixing device fixes the applied toner on the sheet of printing paper. Then, the paper ejecting device receives the sheet of printing paper, on which a developer is fixed, from the fixing device and ejects the paper to the outside. Here, the developing device includes a photosensitive body, a developing roller, and a transferring roller. When a latent image is formed on the photosensitive body exposed to a predetermined optical scan, the developing roller develops the latent image by supplying the toner, and then the transferring roller transfers the image developed on the photosensitive body to the sheet of printing paper.

As for the developing device, there is a one-component developing device using only the toner, and there is a two-component developing device using a developer obtained by mixing and stirring a nonmagnetic toner and a magnetic carrier. Compared to the one-component developing device, the two-component developing device is excellent in development speed and a grayscale representation.

The two-component developing device generally employs a carrier having a small diameter to maintain high resolution for a long time. As the diameter of the carrier gets smaller, the surface area per unit weight thereof increases. Therefore, the carrier having a small diameter is robust to deterioration owing to the toner adhered thereto. Further, because the carrier having a small diameter translates into a carrier having a small particle, it is possible to achieve high resolution.

Here, the carrier having a small diameter is easily adhered to the photosensitive body in a developing process. Accordingly, various methods have been proposed to solve the problem of carrier adherence having a small diameter. In one method, for example, the attractive force of a magnet roller attracting the developer can be strengthened by increasing the magnetic force of a carrier or the magnet roller so as to suppress the carrier adherence. In another example, the carrier adherence is suppressed by reducing the amount of developer carried in a developing sleeve, which is disclosed in Japanese Patent Publication No. 1996-82958.

However, when the attractive force of the magnet roller is strengthened, image quality is deteriorated, e.g., a bad halftone image, a brush mark, etc. When the amount of the carried developer is reduced, image density is deteriorated. To enhance the image density, an AC type developing bias is needed but causes an electric leak. Therefore, the resistance of the carrier and the condition of the developing bias should be additionally limited.

### SUMMARY OF THE INVENTION

Accordingly, it is an aspect of the present invention to provide a two-component developing device and an image forming apparatus including the same, in which carrier adherence is prevented even though a carrier having a small diameter is used, and resolution is improved.

The foregoing and/or other aspects of the present invention are achieved by providing a two-component developing device including a photosensitive body, a hollow developing sleeve rotating oppositely to the photosensitive body and carrying a mixed developer of a carrier and a toner, and a magnet roller provided inside the developing sleeve and generating a predetermined magnetic field to form a developing zone between the photosensitive body and the developing sleeve, through which the toner is moved to the photosensitive body, wherein the carrier has a magnetic force of 50 through 70 emu/g; the carrier has a mean particle diameter of 20 through 40 μm; the developer has a chargeability of 60 through 110%; and the diameter ratio of the developing sleeve (Dd) to the photosensitive body (Do) ranges between 0.73 and 1 (i.e., 0.73≦Dd/Do≦1).

According to an aspect of the present invention, the attractive force (F) of the magnet roller attracting the developer satisfies the following inequality:
0≦(Fmax−Fmin)/Fave×100≦15

where, Fmax is the maximum attractive force within the developing zone, Fmin is the minimum attractive force within the developing zone, and Fave is the average attractive force within the developing zone.

According to an aspect of the present invention, the chargeability of the developer satisfies the following expression:
Developer chargeability (%)=Q×100(r×l)

where, Q is the amount (g/cm²) of the developer carried per unit area of the developing sleeve within the developing zone, r is the bulk density (g/cm³) of the developer, and l is the gap (cm) between the developing sleeve and the photosensitive body.

The foregoing and/or other aspects of the present invention are achieved by providing an image forming apparatus including a paper feeding device (not shown), a paper ejective device (not shown), a fixing device (not shown) and a two-component developing device that includes a photosensitive body, a hollow developing sleeve rotating oppositely to the photosensitive body and carrying a mixed developer of a carrier and a toner, and a magnet roller provided inside the developing sleeve and generating a predetermined magnetic field to form a developing zone between the photosensitive body and the developing sleeve, through which the toner is moved to the photosensitive body, wherein the carrier has a magnetic force of 50 through 70 emu/g; the carrier has a mean particle diameter of 20 through 40 μm; the developer has a chargeability of 60 through 110%; and the diameter ratio of the developing sleeve (Dd) to the photosensitive body (Do) ranges between 0.73 and 1 (i.e., 0.73≦Dd/Do≦1).

According to an aspect of the present invention, the attractive force (F) of the magnet roller attracting the developer satisfies the following inequality:
0≦(Fmax−Fmin)/Fave×100≦15

where, Fmax is the maximum attractive force within the developing zone, Fmin is the minimum attractive force within the developing zone, and Fave is the average attractive force within the developing zone.

According to an aspect of the present invention, the chargeability of the developer satisfies the following expression:
Developer chargeability (%)=Q×100/(r×l)

where, Q is the amount (g/cm²) of the developer carried per unit area of the developing sleeve within the developing zone, r is the bulk density (g/cm³) of the developer, and l is the gap (cm) between the developing sleeve and the photosensitive body.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a schematic view of a two-component developing device according to an embodiment of the present invention;

FIG. 2 is a view for describing the two-component developing device according to an embodiment of the present invention;

FIGS. 3A-3C show graphs based on experimental results according to embodiments of the present invention;

FIGS. 4A-4C show graphs based on experimental results according to comparative examples; and

FIG. 5 illustrates an image forming apparatus including the developing device according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below so as to explain the present invention by referring to the figures.

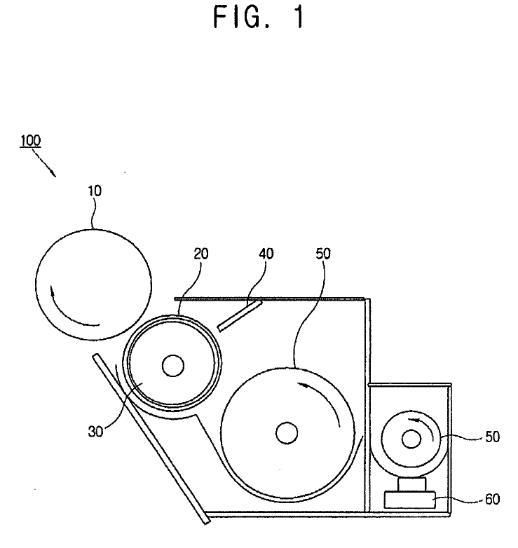

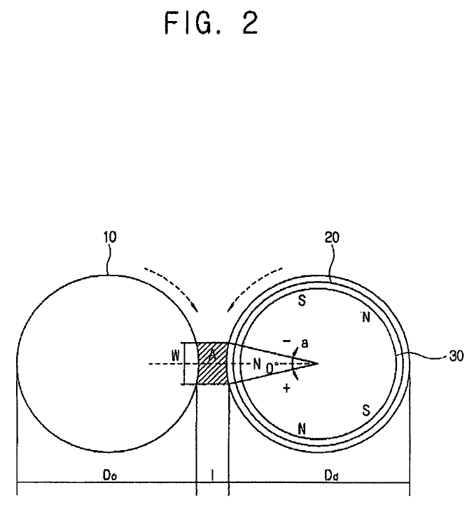

FIGS. 1 and 2 are schematic views of a two-component developing device according to an embodiment of the present invention. As shown therein, a two-component developing device 100 according to an embodiment of the present invention includes a photosensitive body 10, a developing sleeve 20, and a magnet roller 30. The photosensitive body 10 is exposed to light of a predetermined optical scanning unit (not shown), thereby forming an electrostatic latent image. Then, the photosensitive body 10 receives a toner from the developing sleeve 20, thereby developing the electrostatic latent image.

The developing sleeve 20 is shaped like a cylinder, and rotates oppositely to the photosensitive body 10. The developing sleeve 20 uses a magnetic force to attract a developer from a stirring carrying unit 50 which includes two drums. Thus, the developing sleeve 20 adheres the developer to its surface and then carries the developer to a space between itself and the photosensitive body 10. Here, the developing sleeve 20 can be made of aluminum alloy or nonmagnetic stainless steel, and have a rough surface. Further, the developing sleeve 20 is connected to a high voltage terminal (not shown), and thus a developing bias voltage is applied to the developing sleeve 20. The developing bias voltage may be either of a DC voltage or an AC voltage.

The magnet roller 30 is provided inside the developing sleeve and does not rotate relative to the photosensitive body 10. The magnet roller 30 includes a plurality of magnets different in magnetic flux density and polarity from each other and arranged along a circumferential direction, thereby generating a predetermined magnetic field.

The magnet roller 30 forms a developing pole in a direction facing toward the photosensitive body 10. When the developing bias voltage is applied to the magnet roller 30, a developing zone A is formed, in which a toner adhered to a carrier is moved from a magnetic brush formed on a surface adjacent to the developing pole of the developing sleeve 20 to the electrostatic latent image of the photosensitive body 10.

The developer is made by mixing and stirring a magnetic carrier and a nonmagnetic toner. When a toner supply (not shown) supplies the toner to the stirring carrying unit 50, the stirring carrying unit 50 mixes and stirs the toner into the contained carrier. Then, the stirring carrying unit 50 carries the mixed developer of the toner and the carrier toward the developing sleeve 20. At this time, the developer adheres to the developing sleeve 20 by the magnetic force of the magnet roller 30.

A toner density sensor 60 senses toner density of the developer contained in the stirring carrying unit 50, and allows the toner supply to additionally supply the toner when the density of the developer is less than a predetermined density. A doctor blade 40 is spaced apart from the developing sleeve 20 at a predetermined distance and limits the applied thickness of the developer adhered to the surface of the developing sleeve 20, thereby adjusting the amount of the developer carried in the developing device 20.

Preferably, but not necessarily, the carrier has a magnetic force of 50 through 70 emu/g and a mean particle diameter of 20 through 40 μm. Further, the developer preferably, but not necessarily, has a chargeability of 60 through 110%. Also, the diameter ratio of the developing sleeve 20 having a diameter Dd to the photosensitive body 10 having a diameter Do preferably ranges between 0.73 and 1 (i.e., 0.73≦Dd/Do≦1). The chargeability of the developer can be obtained by the following expression.
Developer chargeability (%)=Q×100/(r×l)

Where, Q is the amount (g/cm²) of the developer carried per unit area of the developing sleeve 20 within the developing zone A, r is the falling density (g/cm³) of the developer, where a falling density is mass per unit volume of the developer free-fallen and accumulated, and l is the gap (cm) between the developing sleeve 20 and the photosensitive body 10.

Further, it is preferable, but not necessary, that the attractive force F of the magnet roller 30 attracting the developer satisfies the following inequality.
0≦(Fmax−Fmin)/Fave×100≦15

Where, Fmax is the maximum attractive force F within the developing zone A, Fmin is the minimum attractive force F within the developing zone A, and Fave is the average attractive force F within the developing zone A. The attractive force F for the developer can be obtained by the following approximate expression.
F=B²+400×(dB/da)²

Where, B is the normal magnetic force (mT) of the magnet roller 30 within the developing zone A, and a is the angle (°) of the magnet roller 30.

Besides, variables such as the developing bias voltage, the resistance of the carrier, etc., which are not described above, may be determined as typical conditions.

Below, operations of the two-component developing device according to an embodiment of the present invention and the image forming apparatus including the same will be described.

When the attractive force of the magnet roller 30 attracting the developer becomes larger within the developing zone A, the carrier is prevented from being adhered to the photosensitive body 10. However, as the attractive force of the developer becomes larger, a halftone image may be deteriorated, and an image may be contaminated by a brush mark formed on the photosensitive body 10. Such deterioration in image quality limits the magnetic force of the magnet roller 30.

The image quality can be enhanced by extending the width W of the developing zone A, i.e., extending the developing zone A along a circumferential direction. As the width W of the developing zone A is extended, the halftone image can be improved. Further, the image quality can be improved by controlling a forming pattern of a magnetic brush. Because the brush mark is formed when the magnetic brush does not stand and fall within the developing zone A, the magnetic brush should be kept still in a developing process to prevent the brush mark from being formed.

The width W of the developing zone A and the forming pattern of the magnetic brush depend on the diameter ratio of the photosensitive body 10 having the diameter Do to the developing sleeve 20 having the diameter Dd. When the diameter Dd of the developing sleeve 20 is relatively larger than the diameter Do of the photosensitive body 10, the width W of the developing zone A becomes larger and the magnetic brush is kept standing.

For example, under conditions that the carrier has a magnetic force of 50 through 70 emu/g and a mean particle diameter of 20 through 40 μm; and the developer has a chargeability of 60 through 110%, when the diameter ratio of the developing sleeve 20 having a diameter Dd to the photosensitive body 10 having a diameter Do is equal to and larger than 0.73 (i.e., Dd/Do≧0.73), the carrier adherence is remarkably decreased and the image quality is remarkably improved. Under the same conditions, when the diameter Dd of the developing sleeve 20 is larger than the diameter Do of the photosensitive body 10, the toner is defectively sealed and thus scattered, and it is difficult to arrange peripheral devices. Therefore, it is preferable that the diameter ratio of the developing sleeve 20 having a diameter Dd to the photosensitive body 10 having a diameter Do is equal to and smaller than 1 (i.e., Dd/Do≦1).

Thus, when the two-component developing device satisfies the conditions that the carrier has a magnetic force of 50 through 70 emu/g and a mean particle diameter of 20 through 40 μm; the developer has a chargeability of 60 through 110%; and the diameter ratio of the developing sleeve 20 having a diameter Dd to the photosensitive body 10 having a diameter Do ranges between 0.73 and 1, the carrier adherence is prevented even though the carrier has a small diameter to maintain high resolution for a long time, and at the same time the quality of a printed image is improved by enhancing the quality of the halftone image and suppressing the brush mark.

Further, the carrier adherence can be more effectively prevented by uniformizing the attractive force of the magnet roller 30 attracting the developer within the developing zone A as well as just making the attractive force of the magnet roller 30 larger. The attractive force of the magnet roller 30 attracting the developer is determined in accordance with the rate of change between the normal magnetic force B of the magnet roller 30 and the angle a of the magnetic force B, which can be calculated by the foregoing approximate expression. Here, a reference angle (0°) is determined as an angle a of a line connecting the center of the developing sleeve 20 with the center of the photosensitive body 10, and the angle a increases along a rotation direction of the developing sleeve 20.

Thus, the magnetic force B and the angle a of the magnet roller 30 are adjusted to make the attractive force F for the developer satisfy the inequality of 0≦(Fmax−Fmin)/Fave×100≦15 by reducing difference between the maximum attractive force Fmax and the minimum attractive force Fmin, thereby more effectively preventing the carrier from being adhered to the photosensitive body 10.

Below, experimental examples of the two-component developing device according to an embodiment of the present invention and the image forming apparatus including the same will be described.

### Experimental Example 1

Surface potential of photosensitive body: −700V

Developing bias: −550V

Toner: polyester resin, solid mean particle diameter of 8 μm

Carrier: silicon+acrylic coat, ferrite carrier, particle density of 5.5 (g/cm³)

Rate of coating the surface of carrier with toner: 31.8%

Developing gap: 0.65 mm

In this experimental example, the carrier adherence and the quality of the halftone image are fixed while the carrying amount of the developer is adjusted to make the developer have a chargeability of 60 through 110%; the magnetic force and the particle diameter of the carrier are varied; and the diameter ratio of the developing sleeve to the photosensitive body is varied. When the chargeability of the developer is more than 110%, the developer is piled up in the developing zone, and thus overloads torque. On the other hand, when the chargeability of the developer is less than 60%, image density is insufficient.

| | | | Magnetic | | | | |
|---|---|---|---|---|---|---|---|
| | | | force (emu/g) | | | | |
| Developing | | | 36 | 50 | 60 | 70 | 70 |
| sleeve | Photosensitive | | Particle | | | | |
| diameter | body | | diameter (μm) | | | | |
| (mm) | diameter (mm) | ratio | 30 | 20 | 30 | 40 | 50 |
| 25 | 30 | 0.83 | CX | O | O | O | HX |
| 22 | 30 | 0.73 | CX | O | O | O | HX |
| 18 | 30 | 0.60 | CX | HX | HX | HX | HX |
| 16 | 30 | 0.53 | CX | HX | HX | HX | HX |

O: no carrier adherence, good halftone image
CX: carrier adherence
HX: bad halftone image

As an experimental result, in the case where the developer employs the carrier having a magnetic force of 50 through 70 emu/g and a mean particle diameter of 20 through 40 μm, and has a chargeability of 60 through 110%, there is no carrier adherence and the halftone image is good when the diameter ratio of the developing sleeve to the photosensitive body is equal to and larger than 0.73 (i.e., Dd/Do≧0.73).

### Experimental Example 2

Surface potential of photosensitive body: −700V

Developing bias: −550V

Toner: polyester resin, solid mean particle diameter of 8 μm

Carrier: silicon+acrylic coat, ferrite carrier, particle density of 5.5 (g/cm³)

Rate of coating the surface of carrier with toner: 31.8%

Developing gap: 0.65 mm

Magnetic force of carrier: 68 emu/g

Particle diameter of carrier: 36 μm

Diameter of the photosensitive body: φ30 mm

Diameter of the developing sleeve: φ25 mm

In this experimental example, a plurality of magnet rollers different in the attractive force are used in development, and then the carrier adherence is checked. At this time, relation among the maximum attractive force Fmax, the minimum attractive force Fmin, the average attractive force Fave and the carrier adherence is as follows.

| | | | (Fmax − Fmin)/ | |
|---|---|---|---|---|
| | | | Fave × 100 | Carrier |
| | Fmax − Fmin | Fave | (%) | adherence |
| Embodiment 1 | 1412 | 13051 | 10.8 | ◯ |
| Embodiment 2 | 920 | 14043 | 6.6 | ◯ |
| Embodiment 3 | 9900 | 12840 | 14.8 | ◯ |
| Comparative | 2556 | 11057 | 23.1 | Δ |
| example 1 | | | | |
| Comparative | 3261 | 11164 | 29.2 | Δ |
| example 2 | | | | |
| Comparative | 5648 | 12578 | 44.9 | X |
| example 3 | | | | |

◯: no carrier adherence
Δ: some carrier adherence
X: many carrier adherence

As an experimental result, not only making the average attractive force larger but also reducing a difference between the attractive forces is important to suppress the carrier adherence. In particular, when the relation among the maximum, minimum and average attractive forces satisfies the inequality of 0≦(Fmax−Fmin)/Fave×100≦15, the carrier adherence is remarkably suppressed.

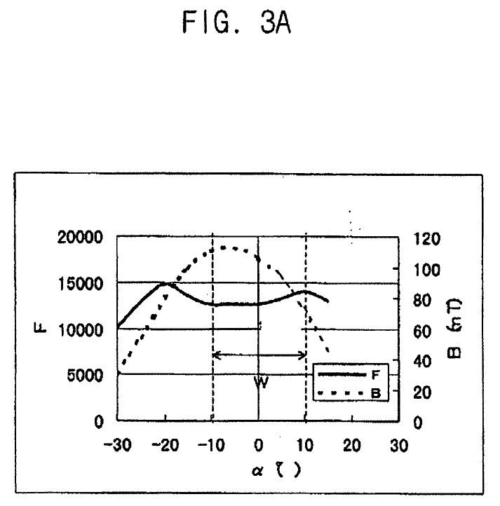

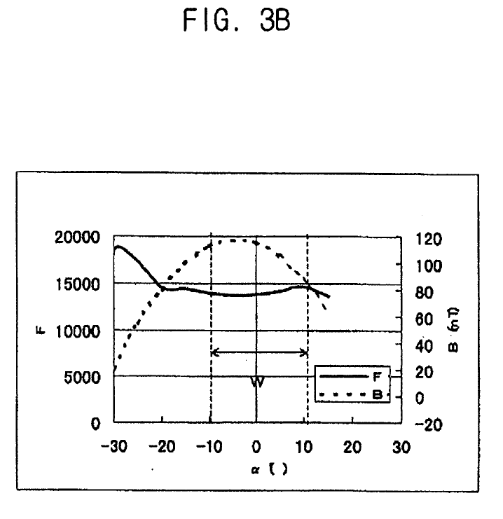

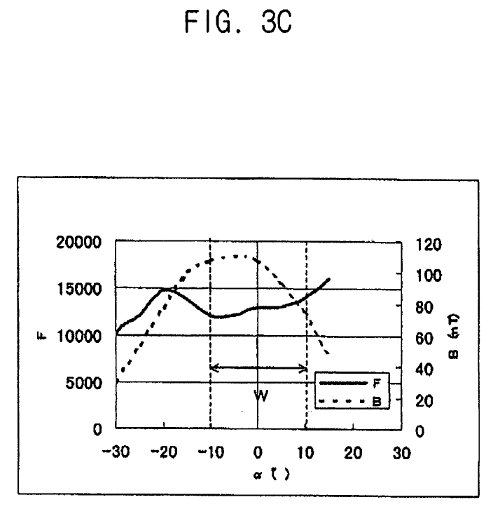

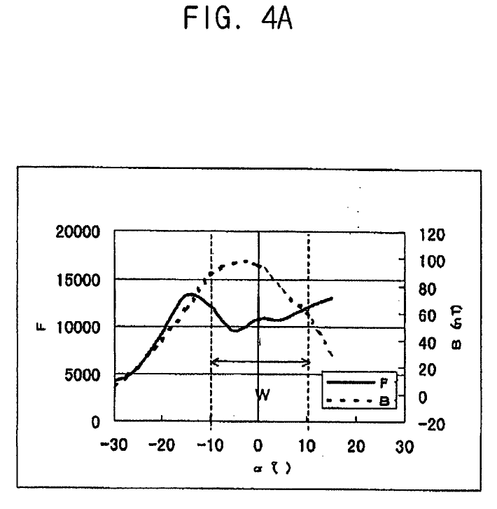

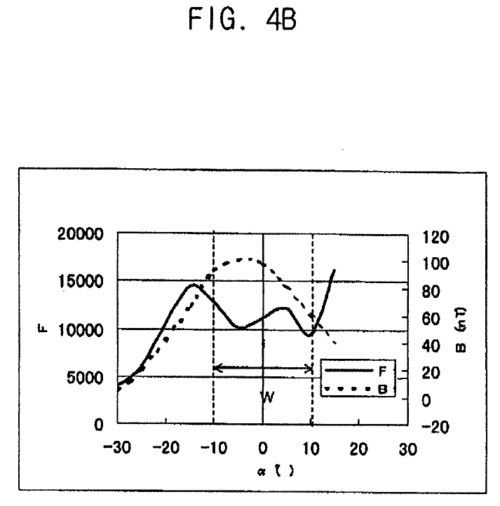

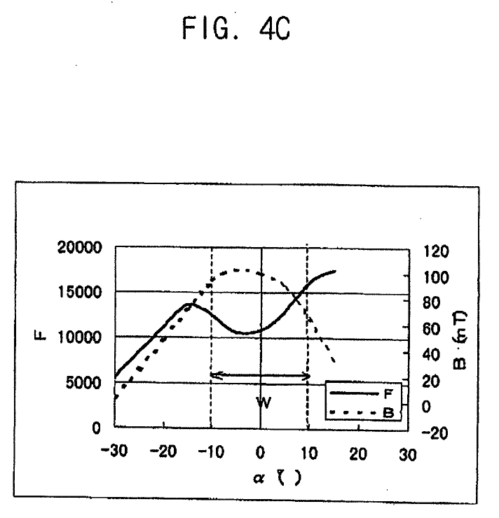

FIGS. 3A-3C and FIGS. 4A-4C show experimental results. FIGS. 3A, 3B and 3C illustrate the attractive forces F of the magnet rollers according to the first, second and third embodiments of the present invention. FIGS. 4A, 4B and 4C illustrate the attractive force F of the magnet rollers according to first, second and third comparative examples. As shown therein, in the graphs according to the first, second and third embodiments resulting in no carrier adherence, the difference between the maximum and minimum attractive forces within the width W of the developing zone A is relatively small. On the other hand, in the graphs according to the first, second and third comparative examples resulting in many carrier adherence, the difference between the maximum and minimum attractive forces within the width W of the developing zone A is relatively large.

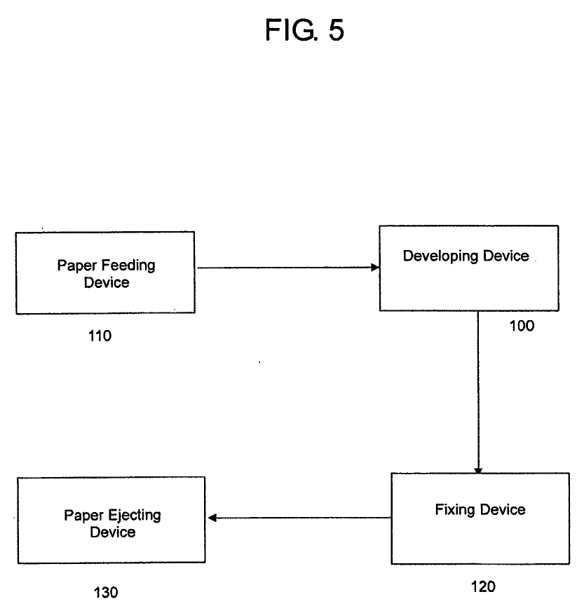

FIG. 5 illustrates an image forming apparatus including the developing device according to an embodiment of the present invention. The image forming apparatus includes a paper feeding device 110, a developing device 100, a fixing device 120 and a paper ejecting device 130. The paper feeding device 110 feeds a sheet of printing paper to the developing device 100. The developing device 100 applies a toner to the sheet of printing paper, thereby forming a predetermined image. Then, the fixing device 120 fixes the applied toner to the sheet of printing paper. Then the paper ejecting device 130 receives the sheet of paper, on which the developer is fixed, from the fixing device 120 and ejects the paper to the outside.

As described above, the present invention provides a two-component developing device and an image forming apparatus including the same, in which carrier adherence is prevented even though a carrier having a small diameter is used, a halftone image is good, and a brush mark is prevented. Therefore, high resolution in printing an image is maintained for a long time.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A two-component developing device comprising a photosensitive body, a hollow developing sleeve rotating oppositely to the photosensitive body and carrying a mixed developer including a carrier and a toner, and a magnet roller provided inside the hollow developing sleeve and generating a predetermined magnetic field to form a developing zone between the photosensitive body and the hollow developing sleeve, through which the toner is moved to the photosensitive body, wherein
the diameter ratio of the hollow developing sleeve (Dd) to the photosensitive body (Do) ranges between 0.73 and 1; and
an attractive force (F) that the magnet roller is attracting the mixed developer in the developing zone satisfies the following inequality:
0≦(Fmax−Fmin)/Fave×100 ≦15
where, Fmax is a maximum attractive force in the developing zone, Fmin is a minimum attractive force in the developing zone, and Fave is an average attractive force in the developing zone.

2. The two-component developing device according to claim 1, wherein
the carrier has a magnetic force of 50 through 70 emu/g;
the carrier has a mean particle diameter of 20 through 40 μm; and
the mixed developer has a chargeability of 60 through 110%;.

3. The two-component developing device according to claim 2, wherein the chargeability of the mixed developer satisfies the following expression:
Developer chargeability (%)=Q×100/(r×l)
where, Q is an amount (g/cm²) of the mixed developer carried per unit area of the hollow developing sleeve within the developing zone, r is a falling density (g/cm³) of the mixed developer, and l is a gap (cm) between the hollow developing sleeve and the photosensitive body.

4. An image forming apparatus comprising:
a paper feeding device;
a developing device;
a fixing device; and
a paper ejecting device,
wherein the developing device includes a two-component developing device that comprises
a photosensitive body;
a hollow developing sleeve rotating oppositely to the photosensitive body and carrying a mixed developer including a carrier and a toner; and
a magnet roller provided inside the hollow developing sleeve and generating a predetermined magnetic field to form a developing zone between the photosensitive body and the hollow developing sleeve, through which the toner is moved to the photosensitive body, wherein
the diameter ratio of the hollow developing sleeve (Dd) to the photosensitive body (Do) ranges between 0.73 and 1; and
an attractive force (F) that the magnet roller is attracting the mixed developer in the developing zone satisfies the following inequality:
0≦(Fmax−Fmin)/Fave×100≦15
where, Fmax is a maximum attractive force in the developing zone, Fmin is a minimum attractive force in the developing zone, and Fave is an average attractive force in the developing zone.

5. The image forming apparatus according to claim 4, wherein
the carrier has a magnetic force of 50 through 70 emu/g;
the carrier has a mean particle diameter of 20 through 40 μm; and
the mixed developer has a chargeability of 60 through 110%.

6. The image forming apparatus according to claim 5, wherein the chargeability of the mixed developer satisfies the following expression:
Developer chargeability (%)=Q−100/(r×l)
where, Q is an amount (g/cm²) of the mixed developer carried per unit area of the hollow developing sleeve within the developing zone, r is a falling density (g/cm³) of the mixed developer, and l is a gap (cm) between the hollow developing sleeve and the photosensitive body.

7. The two-component developing device according to claim 1, wherein the magnet roller includes a plurality of magnets having different magnetic flux density and polarity from each other and the plurality of magnets being arranged in a circumferential direction.

8. The two-component developing device according to claim 1, wherein the magnet roller forms the developing zone in a direction facing the photosensitive body when a voltage is applied to the magnet roller.

9. The two-component developing device according to claim 1, wherein the mixed developer includes a magnetic carrier and a nonmagnetic toner.

10. The two-component developing device according to claim 1, further comprising a stirring carrying unit and a toner density sensor, wherein the toner density sensor senses a toner density of the mixed developer in the stirring carrying unit and controls a toner supply to supply toner when the density of the developer is less than a predetermined density.

11. The two-component developing device according to claim 10, further comprising a blade spaced apart from the hollow developing sleeve at a predetermined distance limiting the applied thickness of the mixed developer to the surface of the hollow developing sleeve.

12. The two-component developing device according to claim 1, wherein image quality is enhanced by extending a width of the developing zone along a circumferential direction along the hollow developing sleeve.

13. A developing device comprising:
a photosensitive body;
a developing sleeve rotating oppositely to the photosensitive body and carrying a toner; and
a magnet roller provided inside the developing sleeve and generating a predetermined magnetic field to form a developing zone between the photosensitive body and the developing sleeve, through which the toner is moved to the photosensitive body,
wherein the diameter ratio of the developing sleeve (Dd) to the photosensitive body (Do) ranges between 0.73 and 1.

14. The developing device according to claim 13, wherein an attractive force (F) of the magnet roller attracting the toner satisfies the following inequality:
0≦(Fmax−Fmin)/Fave×100≦15
where, Fmax is a maximum attractive force within the developing zone, Fmin is a minimum attractive force within the developing zone, and Fave is an average attractive force within the developing zone.

15. The developing device according to claim 13, wherein the magnet roller includes a plurality of magnets having different magnetic flux density and polarity from each other and the magnets are arranged in a circumferential direction.

16. The developing device according to claim 13, wherein the magnet roller forms the developing zone in a direction facing the photosensitive body when a voltage is applied to the magnet roller.

17. The developing device according to claim 13, further comprising a blade spaced apart from the developing sleeve at a predetermined distance, limiting the applied thickness of the toner to the surface of the developing sleeve.
